(19) United States
(12) Patent Application Publication
(10) Pub. No.: US 2020/0194781 A1
(43) Pub. Date: Jun. 18, 2020

(54) SECONDARY BATTERY

(71) Applicant: SANYO Electric Co., Ltd., Osaka (JP)

(72) Inventors: Akihiro Tabushi, Hyogo (JP); Kazuya Hashimoto, Osaka (JP); Yuu Takanashi, Hyogo (JP)

(73) Assignee: SANYO Electric Co., Ltd., Osaka (JP)

(21) Appl. No.: 16/704,199

(22) Filed: Dec. 5, 2019

(30) Foreign Application Priority Data
Dec. 12, 2018 (JP) 2018-232291

(51) Int. Cl. H01M 4/36; H01M 4/505; H01M 4/525

(52) U.S. Cl. CPC H01M 4/364; H01M 2004/027; H01M 4/525; H01M 4/505

(57) ABSTRACT

A secondary battery includes a positive electrode including a positive electrode core; and a positive electrode mixture layer formed on at least one of the surfaces of the positive electrode core. The positive electrode mixture layer has a first positive electrode mixture layer and a second positive electrode mixture layer formed om the surface of the first positive electrode mixture layer. The first positive electrode mixture layer contains a first positive electrode active material having a BET specific surface area of 1.6 m²/g to 2.8 m²/g, and the second positive electrode mixture layer contains a second positive electrode active material having a BET specific surface area of 0.8 m²/g to 1.3 m²/g. The thickness of the second positive electrode mixture layer is 5 μm to 15 μm.

### CROSS REFERENCE TO RELATED APPLICATIONS

The present invention application claims priority to Japanese Patent Application No. 2018-232291 filed in the Japan Patent Office on Dec. 12, 2018, the entire contents of which are incorporated herein by reference.

### BACKGROUND OF THE INVENTION

### Field of the Invention

The present disclosure relates to a secondary battery.

### Description of Related Art

It has been known that the output of a secondary battery is improved by increasing the specific surface area of a positive electrode active material in the secondary battery. For example, Japanese Patent No. 5929183 (Patent Document 1) discloses that the specific surface area of an active material on the current collector side of a positive electrode mixture layer is made larger than that on the surface layer side.

Patent Document 1 also describes that by using the positive electrode mixture layer, the charge-discharge characteristics including output can be enhanced.

### BRIEF SUMMARY OF THE INVENTION

However, in a process for producing a secondary battery, a positive electrode may be stored in the air from the positive electrode forming step to the secondary battery assembly step. The problem of decreasing the output of a secondary battery was found when a positive electrode including a positive electrode mixture layer, which contained a positive electrode active material having a high specific surface area, was stored in the air. An object of the present disclosure is to provide a secondary battery suppressing a decrease in output due to the air exposure of a positive electrode.

According to an aspect of the present disclosure, a secondary battery includes a positive electrode having a positive electrode core and a positive electrode mixture layer formed on at least one of the surfaces of the positive electrode core. The positive electrode mixture layer has a first positive electrode mixture layer and a second positive electrode mixture layer formed on the surface of the first positive electrode mixture layer. The first positive electrode mixture layer contains a first positive electrode active material having a BET specific surface area of 1.6 m²/g to 2.8 m²/g, and the second positive electrode mixture layer contains a second positive electrode active material having a BET specific surface area of 0.8 m²/g to 1.3 m²/g. The thickness of the second positive electrode mixture layer is 5 μm to 15 μm.

According to an aspect of the present disclosure, it is possible to provide a secondary battery suppressing a decrease in output due to the air exposure of a positive electrode.

### BRIEF DESCRIPTION OF THE SEVERAL VIEWS OF THE DRAWINGS

FIG. 1 is a front view of an example of a secondary battery according to an embodiment of the present disclosure, with the front parts of a battery case and of an insulating sheet removed.

FIG. 2 is a plan view of an example of a secondary battery according to an embodiment of the present disclosure.

FIG. 3 is a sectional view of an example of a positive electrode according to an embodiment of the present disclosure.

### DETAILED DESCRIPTION OF THE INVENTION

In a secondary battery, the output of the secondary battery is improved by increasing the BET specific surface area of a positive electrode active material. While as a result of investigation performed by the inventors, it was found that the output of a secondary battery is decreased when a positive electrode including a positive electrode mixture layer, which contains a positive electrode active material having a high BET specific surface area, is stored in the air.

A positive electrode active material having a high BET specific surface area easily forms Li₂CO₃, which is a resistance component, by reaction of the lithium component remaining on the surface of the positive electrode active material with air moisture and carbon dioxide, and thus when stored in the air for a while, the resistance value of the positive electrode mixture layer is increased. Therefore, a secondary battery incorporated with a positive electrode stored in the air for a while is decreased in output as compared with a secondary battery incorporated with a positive electrode on the day of production.

The research performed by the inventors revealed that a decrease in output due to the air exposure of a positive electrode can be suppressed when a secondary battery has the following configuration: The secondary battery includes a positive electrode having a positive electrode core and a positive electrode mixture layer formed on at least one of the surfaces of the positive electrode core. The positive electrode mixture layer has a first positive electrode mixture layer and a second positive electrode mixture layer formed on the surface of the first positive electrode mixture layer. The first positive electrode mixture layer formed on the positive electrode core side contains a first positive electrode active material having a BET specific surface area of 1.6 m²/g to 2.8 m²/g, and the second positive electrode mixture layer formed on the surface of the first positive electrode mixture layer contains a second positive electrode active material having a BET specific surface area of 0.8 m²/g to 1.3 m²/g, and the thickness of the second positive electrode mixture layer is 5 μm to 15 μm. In the specification of the present disclosure, the “air exposure” represents storage in the air. In the positive electrode, the sufficient output can be realized by disposing the first positive electrode mixture layer having a high BET specific surface area on the positive electrode core side. Further, the entrance of air moisture can be inhibited by disposing the second positive electrode mixture layer having a low BET specific surface area on the first positive electrode mixture layer, and thus the formation of Li₂CO₃, which is a resistance component, can be suppressed.

An example of an embodiment of the present disclosure is described below. The embodiment of the present disclosure describes, as an example, a prismatic battery including a battery case 200 serving as a prismatic metal case, but the battery case is not limited to the prismatic shape and may be, for example, a battery case composed of a laminate sheet containing a metal layer and a resin layer. Also, the embodiment describes an example in which mixture layers are formed on both surfaces of each of the cores of both the positive electrode and the negative electrode, but the mixture layer is not limited to the example in which the mixture layers are formed on both surfaces of each of the cores, and the mixture layer may be formed on at least one of the surfaces.

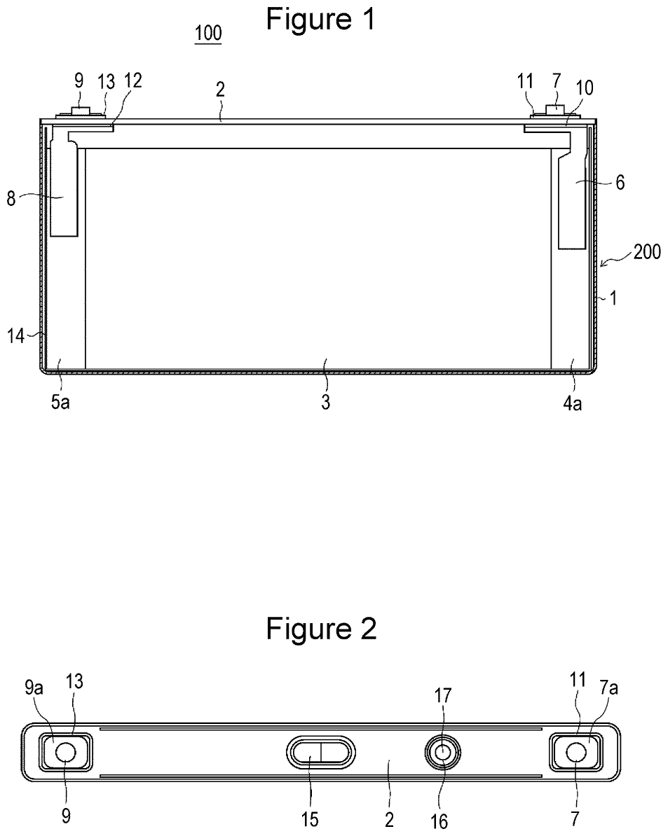

As shown in an example in each of FIG. 1 and FIG. 2, a secondary battery 100 includes a wound electrode body 3, which is obtained by winding a positive electrode and a negative electrode through a separator and forming into a flat shape having a flat part and a pair of curved parts, an electrolyte, and a battery case 200 which houses the electrode body 3 and the electrolyte. The battery case 200 has a prismatic outer case 1 having a bottomed cylindrical shape with an opening and a sealing plate 2 which seals the opening of the prismatic outer case 1. Both the prismatic outer case 1 and the sealing plate 2 are made of a metal and are preferably made of aluminum or an aluminum alloy.

The prismatic outer case 1 has a substantially rectangular bottom in a bottom view and a side wall part erected on the periphery of the bottom. The side wall part is formed perpendicularly to the bottom. The dimensions of the prismatic outer case 1 are not particularly limited, but are, for example, 130 mm to 160 mm in lateral length, 60 mm to 70 mm in height, 15 mm to 18 mm in thickness. In the specification of the present disclosure, for the sake of description, in the prismatic outer case 1, the direction along the longitudinal direction of the bottom of the prismatic outer case 1 is referred to as the “lateral direction”, the direction perpendicular to the bottom is referred to as the “height direction”, and the direction perpendicular to the lateral direction and the height direction is referred to as the “thickness direction”.

The positive electrode is a long body having a metal-made positive electrode core and positive electrode mixture layers formed on both surfaces of the core, and a strip-shaped core exposed portion 4a, where the positive electrode core is exposed along the longitudinal direction, is formed at an end in the lateral direction. Similarly, the negative electrode is a long body having a metal-made negative electrode core and negative electrode mixture layers formed on both surfaces of the core, and a strip-shaped core exposed portion 5a, where the negative electrode core is exposed along the longitudinal direction, is formed at an end in the lateral direction. The electrode body 3 has a structure in which the positive electrode and the negative electrode are wound through the separator so that the core exposed portion 4a of the positive electrode and the core exposed portion 5a of the negative electrode are disposed at the respective ends in the axial direction.

A positive electrode current collector 6 and a negative electrode current collector 8 are connected to the laminated parts of the core exposed portions 4a and 5a of the positive electrode and the negative electrode, respectively. The positive electrode current collector 6 is preferably made of aluminum or an aluminum alloy. The negative electrode current collector 8 is preferably made of copper or a copper alloy. A positive electrode terminal 7 has a flange part 7a, provided on the sealing plate 2 so as to be disposed on the outside of the battery, and an insertion part inserted into a through hole provided in the sealing plate 2, and is electrically connected to the positive electrode current collector 6. Also, a negative electrode terminal 9 has a flange part 9a, provided on the sealing plate 2 so as to be disposed on the outside of the battery, and an insertion part inserted into a through hole provided in the sealing plate 2, and is electrically connected to the negative electrode current collector 8.

The positive electrode current collector 6 and the positive electrode terminal 7 are fixed to the sealing plate 2 through an inner insulating member 10 and an outer insulating member 11, respectively. The inner insulating member 10 is disposed between the sealing plate 2 and the positive electrode current collector 6, and the outer insulating member 11 is disposed between the sealing plate 2 and the positive electrode terminal 7. Similarly, the negative electrode current collector 8 and the negative electrode terminal 9 are fixed to the sealing plate 2 through an inner insulating member 12 and an outer insulating member 13, respectively. The inner insulating member 12 is disposed between the sealing plate 2 and the negative electrode current collector 8, and the outer insulating member 13 is disposed between the sealing plate 2 and the negative electrode terminal 9.

The electrode body 3 is housed in the state of being covered with an insulating sheet 14 inside the prismatic outer case 1. The sealing plate 2 is connected by laser welding or the like to the edge of the opening of the prismatic outer case 1. The sealing plate 2 has an electrolyte injection hole 16 which is sealed with a sealing plug 17 after the electrolyte is injected into the battery case 200. The sealing plate 2 has a gas discharge valve 15 formed for discharging gas when the pressure in the battery is a predetermined value or more.

The positive electrode 4, the negative electrode, the separator, and the electrolyte, which constitute the electrode body 3, particularly the positive electrode mixture layers 41 of the positive electrode 4, are described in detail below.

### [Positive Electrode]

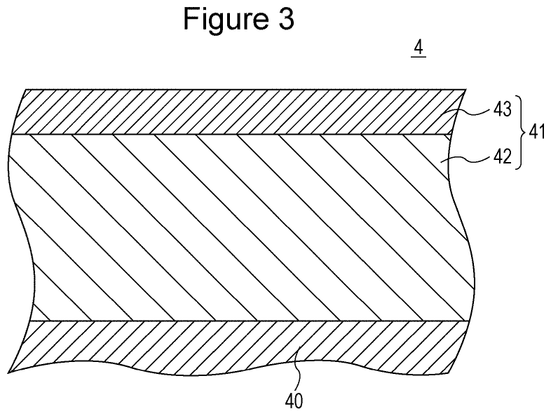

As shown by an example in FIG. 3, the positive electrode 4 includes the positive electrode core 40 and the positive electrode mixture layers 41 formed on the surfaces of the positive electrode core 40. The positive electrode core 40 can be formed by using a foil of a metal, such as aluminum, am aluminum alloy, or the like, which is stable within the potential range of the positive electrode 4, a film having the metal disposed in a surface layer, or the like, and has a thickness of 5 μm to 30 μm. The thickness of the positive electrode mixture layer 41 on one of the surfaces of the positive electrode core 40 is, for example, 15 μm to 150 μm, and preferably 20 μm to 70 μm. The positive electrode mixture layers 41 are preferably provided on both surfaces of the positive electrode core 40.

Each of the positive electrode mixture layers 41 has a first positive electrode mixture layer 42 formed on the positive electrode core 40 side and a second positive electrode mixture layer 43 formed on the surface of the first positive electrode mixture layer 42. The first positive electrode mixture layer 42 contains a first positive electrode active material having a BET specific surface area of 1.6 m²/g to 2.8 m²/g, and the second positive electrode mixture layer 43 contains a second positive electrode active material having a BET specific surface area of 0.8 m²/g to 1.3 m²/g. Each of the positive electrode mixture layers 41 has a laminated structure in which the first positive electrode mixture layer 42 and the second positive electrode mixture layer 43 are superposed in order from the positive electrode core 40 side. Each of the positive electrode mixture layers 41 may have a layer other than the first positive electrode mixture layer 42 and the second positive electrode mixture layer 43.

As described above, the first positive electrode mixture layer 42 contains the first positive electrode active material having a BET specific surface area of 1.6 m²/g to 2.8 m²/g. By forming the first positive electrode active material having a high BET specific surface area on the positive electrode core 40 side, the output of the secondary battery can be increased. The first positive electrode mixture layer 42 can further contain a conductive material and a binder (both not shown). The main component of the first positive electrode mixture layer 42 is the first positive electrode active material. The thickness of the first positive electrode mixture layer 42 is, for example, 5 μm to 145 μm.

The first positive electrode active material and the second positive electrode active material are each, for example, a lithium metal composite oxide containing at least one element selected from Ni, Co, and Mn. That is, the primary particles constituting hollow particles or solid particles in the first positive electrode active material and the second positive electrode active material are composed of a lithium metal composite oxide as a main component. The lithium metal composite oxide is a composite oxide represented by, for example, the general formula LiₓMe_{y}O₂ (0.8≤x≤1.2, 0.7≤y≤1.3). In the formula, Me is a metal element containing at least one selected from Ni, Co, Mn. A preferred example of the lithium metal composite oxide is a composite oxide containing at least one of Ni, Co, and Mn. Examples thereof include a lithium metal composite oxide containing Ni, Co, and Mn, and a lithium metal composite oxide containing Ni, Co, and Al, and the lithium metal composite oxide containing Ni, Co, and Mn is preferred. In addition, inorganic particles of tungsten oxide, aluminum oxide, a lanthanide-containing compound, or the like may be fixed to the particle surfaces of the lithium metal composite oxide.

The elements contained in the lithium metal composite oxide are not limited to Ni, Co, and Mn, and another element may be contained. Examples of the other element include alkali metal elements other than Li, transition metal elements other than Ni, Co, and, Mn, alkaline-earth metal elements, and group 12, group 13, and group 14 elements. Specific examples of the other element include Al, B, Na, K, Ba, Ca, Mg, Ti, V, Cr, Fe, Cu, Zn, Ga, Sr, Zr, Nb, In, Sn, Ta, W, and the like. In a case containing Zr, the crystal structure of the lithium metal composite oxide is generally stabilized, thereby improving the durability at high temperature of and cycle characteristics of the second positive electrode active material. The content of Zr in the lithium metal composite oxide is preferably 0.05 mol % to 10 mol %, more preferably 0.1 mol % to 5 mol %, and particularly preferably 0.2 mol % to 3 mol % relative to the total amount of the metals excluding Li. The lithium metal composite oxides constituting the primary particles of the first positive electrode active material and the second positive electrode active material may be the same as or different from each other. The first positive electrode mixture layer 42 and the second positive electrode mixture layer 43 may contain, for example, the same positive electrode active material.

The first positive electrode active material is composed of secondary particles produced by aggregation of primary particles, and the secondary particles preferably have no primary particles therein or contain a hollow portion having primary particles at a sparse density (the secondary particles having such a structure may be referred to as “hollow particles” hereinafter). By using the hollow particles as the first positive electrode active material, the resistance of the secondary battery can be decreased, and thus the output can be increased.

The hollow particles have a shell which surrounds the hollow portion. The shell of the hollow particles is preferably formed by aggregation of the primary particles. Some primary particles may be present in the hollow portion, but the density of primary particles in the hollow portion is lower than that in the shell. On the other hand, the term “solid particles” represents particles in which the active material is densely present and the density of the active material is substantially uniform on the inside and the outside of the particles. The first positive electrode mixture layer 42 may contain the solid particles within a range in which the object of the present disclosure is not impaired. The volume-based median particle diameter (D50) of the hollow particles is, for example, 2 μm to 30 μm and more preferably 2 μm to 10 μm. In the specification of the present disclosure, the median particle diameter represents the particle diameter (D50) at a cumulative volume value of 50% in the particle size distribution measured by a laser diffraction scattering method unless otherwise specified.

As described above, the hollow particles are secondary particles with a hollow structure, which are formed by aggregation of primary particles. The average particle diameter of the primary particles is, for example, 50 nm to 10 μm, preferably 50 nm to 3 μm, and more preferably 100 nm to 1 μm. The average particle diameter of the primary particles is the value obtained by randomly extracting 100 primary particles from the primary particles observed with a scanning electron microscope (SEM), measuring, as the diameter of each of the particles, the average value of the long diameter and short diameter lengths of each of the particles, and then averaging the particle diameters of 100 particles. The volume of the hollow portion is preferably 10% to 90% and more preferably 15% to 60% of the total volume (including the volume of the hollow portion) of the hollow particles. The volume of the hollow portion is determined by image analysis using SEM.

The second positive electrode mixture layer 43 contains the second positive electrode active material having a BET specific surface area of 0.8 m²/g to 1.3 m²/g. The second positive electrode mixture layer 43 containing as a main component the second positive electrode active material having a low BET specific surface area protects the inner first positive electrode mixture layer 42 from air moisture. The second positive electrode mixture layer 43 may further contain a conductive material and a binder (both not shown).

The thickness of the second positive electrode mixture layer 43 is 5 μm to 15 μm. The second positive electrode mixture layer 43 having a thickness of 5 μm or more satisfactorily functions as a protective layer and can suppress a decrease in output due to the air exposure of the positive electrode 4. The second positive electrode mixture layer 43 having a thickness of 15 μm or less can achieve satisfactory output because the thickness of the first positive electrode mixture layer 42 can be increased.

The second positive electrode active material is composed of secondary particles produced by aggregation of primary particles. If the BET specific surface area of the second positive electrode active material is within the range described above, the second positive electrode active material may be composed of either the hollow particles or solid particles.

The ratio (S2/S1) of the BET specific surface area S2 of the second positive electrode active material to the BET specific surface area S1 of the first positive electrode active material is preferably 0.46 to 0.81. From the viewpoint of suppressing a decrease in output due to the air exposure of the positive electrode, the ratio S2/S1 is preferably 0.46 or more, and from the viewpoint of initial output, the ratio S2/S1 is preferably 0.81 or less.

The thickness of the second positive electrode mixture layer 43 is preferably 10% to 35% of the total thickness of the first positive electrode mixture layer 42 and the second positive electrode mixture layer 43. From the viewpoint of suppressing a decrease in output due to the air exposure of the positive electrode, the thickness of the second positive electrode mixture layer 43 is preferably 10% or more of the total thickness of the first positive electrode mixture layer 42 and the second positive electrode mixture layer 43, and from the viewpoint of initial output, the thickness of the second positive electrode mixture layer 43 is preferably 35% or less of the total thickness.

Examples of the conductive material contained in the first positive electrode mixture layer 42 and the second positive electrode mixture layer 43 include carbon materials such as carbon black, acetylene black, Ketjen black, graphite, and the like. The conductive material is preferably composed of particles having a smaller particle diameter than the hollow particles. The D50 of the conductive material is, for example, preferably 1 nm to 10 nm. The content of the conductive material in each of the first positive electrode mixture layer 42 and the second positive electrode mixture layer 43 is preferably 0.5% by mass to 5% by mass and more preferably 1% by mass to 3% by mass relative to the total mass of the first positive electrode mixture layer 42 or the second positive electrode mixture layer 43.

Examples of the binder contained in the first positive electrode mixture layer 42 and the second positive electrode mixture layer 43 include fluorocarbon resins such as polytetrafluoroethylene (PTFE), polyvinylidene fluoride (PVdF), and the like; polyacrylonitrile (PAN), polyimide resins, acrylic resins, polyolefin resins, and the like. These resins may be used in combination with a cellulose derivative such as carboxymethyl cellulose (CMC), a salt thereof, or the like, polyethylene oxide (PEO), or the like. The content of the binder in each of the first positive electrode mixture layer 42 and the second positive electrode mixture layer 43 is preferably 1% by mass to 7% by mass and more preferably 2% by mass to 4% by mass relative to the total mass of the first positive electrode mixture layer 42 or the second positive electrode mixture layer 43.

The positive electrode mixture layer 41 can be produced by, for example, using a first positive electrode mixture slurry and a second positive electrode mixture slurry. Specifically, the first positive electrode mixture slurry is applied on both surfaces of the positive electrode core 40, and the resultant coating films are dried to form the first positive electrode mixture layers 42. Then, the second positive electrode mixture slurry is applied over the entire region of the surface of each of the first positive electrode mixture layers 42, and the resultant coating films are dried to form the second positive electrode mixture layers 43. Then, the first positive electrode mixture layers 42 and the second positive electrode mixture layers 43 are compressed by using a roller or the like. The slurries each contain the positive electrode active material, the binder, and the conductive material.

### [Negative Electrode]

The negative electrode includes a negative electrode core and negative electrode mixture layers provided on the surfaces of the negative electrode core. The negative electrode core can be obtained by using a foil of a metal such as copper, a copper alloy, or the like, which is stable within the potential range of the negative electrode, a film containing the metal disposed in a surface layer, or the like. The negative electrode mixture layers contain a negative electrode active material and a binder such as styrene butadiene rubber (SBR) or the like, and are preferably provided on both surfaces of the negative electrode core. The negative electrode can be produced by applying a negative electrode mixture slurry, containing the negative electrode active material, the binder, etc., on the surfaces of the negative electrode core, and the coating films are dried and then compressed to form the negative electrode mixture layers on both surfaces of the negative electrode core.

Each of the negative electrode mixture layers contains the negative electrode active material, the binder, etc. The negative electrode active material can reversibly absorb and desorb lithium ions, and examples thereof include graphite-based carbon materials such as natural graphite, artificial graphite, and the like; amorphous carbon materials; metals such as Si, Sn, and the like, which are alloyed with lithium, alloy materials and composite oxides of these metals; and the like. These may be used alone or as a mixture of two or more. In particular, in view of easy formation of a low-resistance film on the surfaces of the negative electrode, it is possible to use a carbon material containing a graphite-based carbon material and an amorphous carbon material fixed to the surface of the graphite-based carbon material.

The graphite-based carbon material is a carbon material in which a graphite crystal structure is developed, and examples thereof include natural graphite, artificial graphite, and the like. These may be flake-shaped or may be processed to a spherical shape by treatment of spheroidization. The artificial graphite can be produced by heat treatment of a raw material, such as petroleum, coal pitch, coke, or the like, in an Acheson furnace, a graphite heater furnace, or the like at 2000° C. to 3000° C. or more. The d(002) spacing in X-ray diffraction is preferably 0.338 nm or less, and the crystal thickness (Lc (002)) in the c-axis direction is preferably 30 nm to 1000 nm.

The amorphous carbon material is a carbon material in which a graphite crystal structure is not developed and carbon has an amorous or microcrystalline turbostratic structure. More specifically, it represents that the d(002) spacing in X-ray diffraction is 0.342 nm or more. Examples of the amorphous carbon material include hard carbon (non-graphitizable carbon), soft carbon (graphitizable carbon), carbon black, carbon fibers, activated carbon, and the like. The method for producing these materials is not particularly limited. The amorphous carbon material can be produced by, for example, carbiding a resin or a resin composition, and a phenolic thermosetting resin, a thermoplastic resin such as polyacrylonitrile or the like, petroleum- or coal-based tar or pitch, or the like can be used. Also, for example, carbon black can be produced by thermal decomposition of the hydrocarbon used as a raw material. Examples of a thermal decomposition method include a thermal method, an acetylene decomposition method, and the like. Examples of an incomplete combustion method include a contact method, a lamp/pine soot method, a gas furnace method, an oil furnace method, and the like. Examples of carbon black produced by these production methods include acetylene black, Ketjen black, thermal black, furnace black, and the like. These amorphous carbon materials may be further surface-coated with another amorphous or unshaped carbon.

Also, the amorphous carbon material is preferably present in the state of being fixed to the surface of the graphite-based carbon material. The term “fixed” represents the state of being chemically/physically bonded and represents that the amorphous carbon material is not separated from the graphite-based carbon material even when the negative electrode active material is stirred in water or an organic solvent. A film with a low reaction overvoltage can be formed on the surface of the graphite-based carbon material by fixing, to the surface of the graphite-based carbon material, the amorphous carbon material having a large reaction area and multi-orientation tissue structure as compared with the graphite-based carbon material. Therefore, the reaction overvoltage for Li insertion/elimination reaction is considered to be decreased over the entire of the graphite-based carbon material. Further, the amorphous carbon material has a noble reaction potential as compared with the graphite-based carbon material and thus preferentially reacts with the group 5/group 6 element eluted from the positive electrode, forming a good film having more excellent lithium ion permeability on the surface of the amorphous carbon material. Therefore, the reaction resistance to Li insertion/elimination reaction is considered to be further decreased over the entire of the graphite-based carbon material.

The ratio between the graphite-based carbon material and the amorphous carbon material is not particularly limited, but the ratio of the amorphous carbon material having excellent Li absorption properties is preferably higher than the ratio of the graphite-based carbon material. The ratio of the amorphous carbon material in the active material is preferably 0.5% by mass or more and more preferably 2% by mass or more. However, the excessive amorphous carbon material cannot be uniformly fixed to the surface of the graphite-based carbon material, and thus the upper limit is preferably determined in consideration of this point.

Examples of a method for fixing the amorphous carbon material to the graphite-based carbon material include a method of adding petroleum- or coal-based tar or pitch, or the like to the amorphous carbon material and mixing with the graphite-based carbon material, and then heat-treating the resultant mixture, a mechanofusion method of coating by applying a compressive shear stress between graphite particles and the solid amorphous carbon material, a solid-phase method of coating by a sputtering method, a liquid-phase method of immersing graphite in a solvent such as toluene or the like, in which the amorphous carbon material is dissolved, and then heat-treating the solvent, and the like.

From the viewpoint of Li diffusion distance, the amorphous carbon material preferably has a small primary particle diameter, and in view of the increased reaction surface area for Li absorption reaction, the amorphous carbon material preferably has a large the specific surface area. However, with the excessively large specific surface area, excessive reaction occurs on the surface, leading to an increase in resistance. Therefore, the BET specific surface area of the amorphous carbon material is preferably 5 m²/g to 200 m²/g. In order to decrease the excessive specific surface area, the primary particle diameter is preferably 20 nm to 1000 nm and more preferably 40 nm to 100 nm. Further, the amorphous carbon material preferably does not have a hollow structure in which cavities are present in the particles.

In addition, a metal such as Si, Sn, or the like, which is alloyed with lithium, or an alloy or composite oxide of the metal, or the like is preferably a silicon compound such as, silicon oxide or the like represented by SiOₓ (0.5≤x≤1.6) and containing Si. The median particle diameter (D50) of the negative electrode active material is, for example, 5 μm to 30 μm.

Like in the positive electrode, usable examples of the binder include fluorocarbon resins, PAN, polyimide resins, acrylic resins, polyolefin resins, and the like. When the negative electrode mixture slurry is prepared by using an aqueous solvent, preferably used is styrene-butadiene rubber (SBR), CMC or a salt thereof, polyacrylic acid (PAA) or a salt thereof (PAA-Na, PAA-K, or the like, or a partially neutralized salt), polyvinyl alcohol (PVA), or the like.

[Separator]

A porous sheet having ion permeability and insulation can be used as the separator. Examples of the porous sheet include a microporous thin film, a woven fabric, a nonwoven fabric, and the like. The material of the separator is preferably an olefin resin such as polyethylene, polypropylene, or the like, or cellulose. The separator may be a laminate having a cellulose fiber layer and a thermoplastic resin fiber layer of an olefin resin or the like. Also, the multilayer separator containing a polyethylene layer and a polypropylene layer may be used, and the separator having a surface coated with a resin such as an aramid resin or the like may be used. [Electrolyte]

The electrolyte contains a solvent and an electrolyte salt dissolved in the solvent. The solvent is, for example, a nonaqueous solvent. Examples of the nonaqueous solvent which may be used include ethers, nitriles, carbonates, esters, amides, and mixed solvents of two or more of these. Examples of ethers include cyclic ethers such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfruan, 1,8-cineol, crown ether, and the like; chain ethers such as diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, tetraethylene glycol dimethyl ether, and the like; and the like. Examples of nitriles include acetonitrile, propionitrile, butyronitrile, valeronitrile, n-heptanenitrile, succinonitrile, glutaronitrile, adiponitrile, pimeronitrile, 1,2,3-propanetricarbonitrile, 1,3,5-pentanetricarbonitrile, and the like. Examples of carbonates include cyclic carbonates such as ethylene carbonate (EC), propylene carbonate (PC), butylene carbonate, vinylene carbonate, and the like; and chain carbonates such as dimethyl carbonate (DMC), methyl ethyl carbonate (MEC), diethyl carbonate (DEC), methyl propyl carbonate, ethyl propyl carbonate, methyl isopropyl carbonate, and the like. Examples of esters include chain carboxylate esters such as methyl propionate (MP), ethyl propionate, methyl acetate, ethyl acetate, propyl acetate, and the like; and cyclic carboxylate esters such as γ-butyrolactone (GBL), γ-valerolactone (GVL), and the like. The nonaqueous solvent may contain a halogen-substituted compound produced by substituting at least a portion of hydrogen of any one of these solvents with a halogen atom such as fluorine or the like. Examples of the halogen-substituted compound include fluorinated cyclic carbonate esters such as 4-fluoroethylene carbonate (FEC) and the like; fluorinated chain carbonate esters, fluorinated chain carboxylate esters such as methyl 3,3,3-trifluoropropionate (FMP) and the like; and the like.

The electrolyte salt is preferably a lithium salt. A lithium salt which is generally used as a supporting salt in a usual; secondary battery can be used. Examples thereof include LiBF₄, LiClO₄, LiPF₆, LiAsF₆, LiSbF₆, LiAlCl₄, LiSCN, LiCF₃SO₃, LiC(C₂F₅SO₂), LiCF₃CO₂, Li(P(C₂O₄)F₄), Li(P(C₂O₄)F₂), LiPF₆₋ₓ(CnF₂ₙ₊₁) x (1≤x≤6, n is 1 or 2), LiB₁₀Cl₁₀, LiCl, LiBr, LiI, chloroborane lithium, lithium lower aliphatic carboxylates, borate salts such as Li₂B₄O₇, Li(B(C₂O₄)₂) [lithium bisoxalate borate (LiBOB)], Li(B(C₂O₄)F₂), and the like; imide salts such as LiN(FSO₂)₂, LiN(C₁F₂ₗ₊₁SO₂) (CₘF₂ₘ₊₁SO₂) {l and m are each an integer of 1 or more}, and the like; LiₓP_{y}O_{z}F_{α} (x is an integer of 1 to 4, y is 1 or 2, z is an integer of 1 to 8, and α is an integer of 1 to 4); and the like. Among these, LiPF₆ and LiₓP_{y}O_{z}F_{α} (x is an integer of 1 to 4, y is 1 or 2, z is an integer of 1 to 8, and α is an integer of 1 to 4) are preferred. Examples of LiₓP_{y}O_{z}F_{α} include lithium monofluorophosphate, lithium difluorophosphate, and the like. These lithium salts may be used alone or as a mixture of plural types.

### EXAMPLES

The present disclosure is described in further detail below by examples, but the present disclosure is not limited to these examples.

### Example 1

### [Formation of Positive Electrode]

Hollow particles of lithium metal composite oxide having a BET specific surface area of 1.8 m²/g and represented by LiNi_{0.35}Co_{0.35}Mn_{0.30}O₂ were used as a first positive electrode active material. The first positive electrode active material, polyvinylidene fluoride, and carbon black were mixed at a solid content mass ratio of 90:3:7, and a proper amount of N-methyl-2-pyrrolidone (NMP) was added to the resultant mixture to prepare a first positive electrode mixture slurry. Next, the first positive electrode mixture slurry was applied to both surfaces of a positive electrode core composed of an aluminum foil having a thickness of 15 μm, and the coating films were dried to form first positive electrode mixture layers (uncompressed). The BET specific surface area of the first positive electrode active material was measured by using Macsorb HM model-1201 before mixed with the other components. Hereinafter, the BET specific surface area of second positive electrode mixture layers was measured by the same method as for the first positive electrode mixture layers.

Next, a second positive electrode mixture slurry was prepared by using, as a second positive electrode active material, particles of a lithium metal composite oxide having a BET specific surface area of 1.3 m²/g and represented by LiNi_{0.35}Co_{0.35}Mn_{0.30}O₂. The second positive electrode mixture slurry was prepared by the same method as for preparing the first positive electrode mixture slurry except that the first positive electrode active material was replaced by the second positive electrode active material. Next, the second positive electrode mixture slurry was applied to the surfaces of the first positive electrode mixture layers, and the coating films were dried to form second positive electrode mixture layers over the entire surface regions of the first positive electrode mixture layers. The dried coating films were compressed by using a roller and then cut into a predetermined electrode size, producing a positive electrode having the positive electrode mixture layers formed on both surfaces of a square positive electrode core. In addition, a positive electrode core exposed portion was provided at an end of the positive electrode.

In the step of compressing the positive electrode mixture layers, the compression conditions were adjusted so that the packing density of the positive electrode mixture layers after compression was 2.4 g/cm³. The thicknesses of the first positive electrode mixture layer and the second positive electrode mixture layer after compression were 40 μm and 5 μm, respectively.

### [Formation of Negative Electrode]

Graphite having a median particle diameter of 15 styrene-butadiene rubber (SBR), and carboxymethyl cellulose (CMC) were mixed at a solid content mass ratio of 98:1:1, and a proper amount of water was added to the resultant mixture to prepare a negative electrode mixture slurry. Next, the negative electrode mixture slurry was applied to both surfaces of a negative electrode core composed of a copper foil having a thickness of 10 μm, and the coating films were dried. The dried coating films were compressed by using a roller so that the packing density was 1.2 g/cm³ and then cut into a predetermined electrode size, forming a negative electrode having negative electrode mixture layers formed on both surfaces of a square negative electrode core. In addition, a negative electrode core exposed portion was provided at an end of the negative electrode.

### [Formation of Electrode Body]

The positive electrode and the negative electrode formed as described above were wound through a separator made of strip-shaped polypropylene and having a thickness of 20 μm, and the resultant wound body was formed into a flat shape by radially pressing, thereby forming a wound electrode body. In this case, the wound body was formed by superposing the positive electrode, the negative electrode, and the separator in the order of separator/positive electrode/separator/negative electrode and then winding around a cylindrical winding core (the two separators used were the same). Also, the positive electrode and the negative electrode were wound so that the core exposed portions were located on the opposite sides in the axial direction of the wound body.

### [Preparation of Electrolyte]

Ethylene carbonate (EC), ethylmethyl carbonate (EMC), and diethyl carbonate (DEC) were mixed at a volume ratio of 25:35:40 (25° C., 1 atm). In the resultant mixed solvent, LiPF6 at a concentration of 1 mol/L, lithium bis-oxalate borate (LiBOB) at a concentration of 0.1 mol/L, and lithium difluorophosphate at a concentration of 0.05 mol/L were dissolved, and further 0.8% by mass of vinylene carbonate (VC) relative to the total mass of the electrolyte was added, thereby preparing an electrolyte.

### [Formation of Secondary Battery]

A secondary battery (prismatic battery) was formed by using the electrode body, the electrolyte, and a prismatic battery case. A positive electrode terminal was attached to a sealing plate, constituting the battery case, and a positive electrode current collector was connected to the positive electrode terminal. Also, a negative electrode terminal was attached to the sealing plate, and a negative electrode current collector was connected to the negative electrode terminal. Then, the positive electrode current collector and the negative electrode current collector were welded to the core exposed portions of the positive electrode and the negative electrode, respectively. The electrode body integrated with the sealing plate was housed in the state of being disposed in an insulating sheet, which was formed in a box shape, inside a prismatic bottomed cylindrical outer case (lateral direction length: 148.0 mm (inner dimension 146.8 mm), thickness; 17.5 mm (inner dimension 16.5 mm), and height: 65.0 mm (inner dimension 64.0 mm)) constituting the battery case. Then, an opening of the outer case was sealed with the sealing plate. Then, 35 g of the electrolyte was injected from an electrolyte injection hole of the sealing plate, and then electrode body was sufficiently immersed in the electrolyte. Then, pseudo charging was performed, and a sealing plug was attached to the electrolyte injection hole, thereby forming a secondary battery (battery capacity: 5 Ah).

### Examples 2 to 4 and Comparative Examples 1 to 4

In Examples 2 to 4 and Comparative Examples 1 to 4, secondary batteries were formed by the same method as in Example 1 except that the thickness (T1) of the first positive electrode mixture layer, the thickness (T2) of the second positive electrode mixture layer, the BET specific surface area (S1) of the first positive electrode mixture layer, and the BET specific surface area (S2) of the second positive electrode mixture layer were changed according to Table 1.

The secondary battery of each of the examples and the comparative examples was evaluated for the initial output and the output after an air exposure test, and the evaluation results are shown in Table 1.

### [Evaluation of Initial Output]

A secondary battery was formed by using the positive electrode on the day of production. Then, the secondary battery was charged to 50% of the state of charge (SOC) in a temperature environment of 25° C. Next, the maximum current value which enabled discharge for 10 seconds at a discharge termination voltage of 3.0 V was measured at a temperature environment of 25° C., and the output value at SOC 50% was determined by a formula below. The initial output value of 1045 W or more was evaluated as “A”, the initial output value of less than 1045 W and 1010 W or more was evaluated as “B”, and the initial output value of less than 1010 W was evaluated as “C”.

Output vale (W)=maximum current value (A)×discharge termination voltage (3.0 V)

### [Evaluation of Output After Air Exposure Test]

The positive electrode was stored in a constant-temperature bath at a temperature of 30° C. and a humidity of 50% for 10 days, and then a secondary battery was formed by using the positive electrode. Then, the output after the air exposure was measured by the same method as for evaluation of the initial output, and the output retention rate (output after air exposure/initial output) after the air exposure test was calculated. The output retention rate of 93% or more was evaluated as “A”, and the output retention rate of less than 93% was evaluated as “B”.

Based on the results of the initial output and the results of the output retention rate after the air exposure test, when the initial output is “A” and the output retention is “A”, the overall evaluation was “A”, and when the initial output is “A” and the output retention is “B”, the overall evaluation was “C”. Further, when the initial output is “B” and the output retention is “A”, the overall evaluation was “B”, and when the initial output is “C” and the output retention is “A”, the overall evaluation was “C”.

TABLE 1

| | | Output | Output | | | | | | |
|---|---|---|---|---|---|---|---|---|---|
| | Initial | after air | retention | | | | | | |
| | output) | exposure | rate | T1 | T2 | S1 | S2 | | Overall |
| | (W) | (W) | (%) | (μm) | (μm) | (m²/g) | (m²/g) | S2/S1 | evaluation |
| Example 1 | A 1049 | 986 | A 94 | 40 | 5 | 1.8 | 1.3 | 0.72 | A |
| Example 2 | B 1017 | 955 | A 94 | 40 | 5 | 1.6 | 1.3 | 0.81 | B |
| Example 3 | A 1082 | 1006 | A 93 | 40 | 5 | 2.8 | 1.3 | 0.46 | A |
| Example 4 | B 1027 | 975 | A 95 | 30 | 15 | 1.8 | 1.3 | 0.72 | B |
| Comparative | A 1051 | 967 | B 92 | 42 | 3 | 1.8 | 1.3 | 0.72 | C |
| Example 1 | | | | | | | | | |
| Comparative | C 1007 | 956 | A 95 | 25 | 20 | 1.8 | 1.3 | 0.72 | C |
| Example 2 | | | | | | | | | |
| Comparative | A 1055 | 938 | B 89 | 45 | 0 | 1.8 | — | — | C |
| Example 3 | | | | | | | | | |
| Comparative | C 947 | 900 | A 95 | 0 | 45 | — | 1.3 | — | C |
| Example 4 | | | | | | | | | |

T1: Thickness of first positive electrode mixture layer
T2: Thickness of second positive electrode mixture layer
S1: BET specific surface area of first positive electrode mixture layer
S2; BET specific surface area of second positive electrode mixture layer

Table 1 indicates that in the secondary batteries of Comparative Examples 1 and 3 in which the thickness of the second positive electrode mixture layers is smaller than 5 μm, a decrease in output due to the air exposure of the positive electrode is not satisfactorily suppressed, and the output retention rate is worse than those of the secondary batteries of the examples. In addition, in the secondary batteries of Comparative Examples 2 and 4 in which the thickness of the second positive electrode mixture layers is larger than 15 the initial output is worse than those of the secondary batteries of the examples.

On the other hand, any of the secondary batteries of the examples can suppress a decrease in output due to air exposure of the positive electrode while achieving the satisfactory initial output as compared with the secondary batteries of the comparative examples. The secondary battery of each of the examples includes the first positive electrode mixture layers each containing the first positive electrode active material having a BET specific surface area of 1.6 m²/g to 2.8 m²/g, and the second positive electrode mixture layers each formed on the surface of the first positive electrode mixture layer, containing the second electrode active material having a BET specific surface area of 0.8 m²/g to 1.3 m²/g, and having a thickness of 5 μm to 15 μm. Therefore, a decrease in output due to air exposure of the positive electrode can be suppressed.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A secondary battery comprising:
a positive electrode including a positive electrode core, and a positive electrode mixture layer formed on at least one of the surfaces of the positive electrode core,
wherein the positive electrode mixture layer has a first positive electrode mixture layer and a second positive electrode mixture layer formed om the surface of the first positive electrode mixture layer;
the first positive electrode mixture layer contains a first positive electrode active material having a BET specific surface area of 1.6 m²/g to 2.8 m²/g;
the second positive electrode mixture layer contains a second positive electrode active material having a BET specific surface area of 0.8 m²/g to 1.3 m²/g; and
the thickness of the second positive electrode mixture layer is 5 μm to 15 μm.

2. The secondary battery according to claim 1, wherein the thickness of the second positive electrode mixture layer is 10% to 35% of the total thickness of the first positive electrode mixture layer and the second positive electrode mixture layer.

3. The secondary battery according to claim 1, wherein the ratio (S2/S1) of the BET specific surface area S2 of the second positive electrode active material to the BET specific surface area S1 of the first positive electrode active material is 0.46 to 0.81.

4. The secondary battery according to claim 1, wherein the first positive electrode active material and the second positive electrode active material are each a lithium metal composite oxide containing at least one element selected from Ni, Co, and Mn.

5. The secondary battery according to claim 1, wherein the first positive electrode active material is composed of secondary particles produced by aggregation of primary particles, and the secondary particles do not have the primary particles therein or contain a hollow portion having the primary particles at a sparse density.
